(19) United States
(12) Patent Application Publication
(10) Pub. No.: US 2010/0179851 A1
(43) Pub. Date: Jul. 15, 2010

(54) METHOD AND SYSTEMS FOR GENERATING ENTERPRISE PLANS USING ITERATIVE DISAGGREGATION

(75) Inventor: Edward Michael Sitarski, Toronto (CA)

Correspondence Address: TOWNSEND AND TOWNSEND AND CREW LLP/ORACLE, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/352,471

(22) Filed: Jan. 12, 2009

(51) Int. Cl. G06Q 10/00; G06N 5/02

(52) U.S. Cl. 705/9; 706/52

(57) ABSTRACT

A computing system can execute components for receiving plan inputs that define a timeframe for an enterprise plan. One or more buckets, or time divisions, are created for the timeframe. Experts are defined for each bucket such that the experts create a plan for a time duration that is less than the timeframe. The experts each solve for a plan and then the results are aggregated to generate the enterprise plan. In embodiments, the generated enterprise plan is for a single day of the timeframe. To create a plan for a next day, the timeframe is altered and the process reiterated.

### BACKGROUND

Enterprise planning has become essential in today's business environment. Enterprise planning entails the determination of how to manage a business, taking into account varying business inputs, constraints, and goals. For example, an enterprise plan may determine the number of units of a certain product to manufacture over a given time period. The number of units to manufacture may be driven by orders received or expected demand. Further, the number of units to manufacture may help determine staffing levels, what materials to order, how many shifts to operate, etc. A company can take the varying inputs and desired outputs to determine how to operate the company for a given time.

Unfortunately, current methods for determining the enterprise plan have shortcomings. Many organizations have to plan early for expected demand. This need to plan early may stem from seasonal demand or other business requirements. For example, consider a chocolate bunny manufacturer. Chocolate bunnies are almost exclusively sold on or around Easter. The manufacturer may only be able to produce 1,000 chocolate bunnies per day. Thus, to meet an expected demand of 200,000 chocolate bunnies at Easter, the manufacture must start manufacturing the bunnies 200 days ahead. Similar problems face other companies. Thus, to consider this seasonal demand, an enterprise plan must be created for a timeframe of at least 200 days.

The enterprise generally solves the plan for each day during the entire planning period. For example, the enterprise plan for a 200 day planning period would determine a plan for each of the 200 days. However, solving large plans becomes cumbersome. A single enterprise plan may take days to solve. This inefficiency makes it difficult for organizations to be flexible, responding to new inputs or orders in the near term while continuing to consider requirements in the long term. Adjusting the plan cannot be completed swiftly as all the planning periods must be solved every time a plan is created.

It is in view of these and other considerations not mentioned herein that the embodiments of the present disclosure were envisioned.

### BRIEF SUMMARY

The embodiments presented herein are generally directed to methods and systems for generating enterprise plans. A computing system can execute components for receiving plan inputs that define a timeframe for the plan. One or more buckets, or time divisions, are created for the timeframe. So-called “experts” are defined for each bucket such that the experts create a plan for a time duration that is less than the timeframe. The experts solve for a plan and then the results are aggregated to generate the enterprise plan. In embodiments, the generated enterprise plan is for a single day of the timeframe. To create a plan for a next day, the timeframe is altered and the process reiterated.

This Summary is not meant to limit the possible embodiments in any way. Rather, this Summary describes only some possible embodiments. The scope of the invention is defined by the attached claims.

### BRIEF DESCRIPTION OF THE DRAWINGS

The embodiments of the present disclosure are described in conjunction with the appended figures:

FIGS. 1A-D are process diagrams of an embodiment of a process for generating an enterprise plan;

FIG. 2 is a block diagram of embodiments of components operable to generate an enterprise plan;

FIGS. 3A-C are block diagrams of embodiments of data structures for data used or stored in generating an enterprise plan;

FIG. 4 is a flow diagram of an embodiment of a method for generating an enterprise plan;

FIG. 5 is a block diagram of a computing environment for generating enterprise plans; and

FIG. 6 is a block diagram of a computing system for generating enterprise plans.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides exemplary embodiment(s) only and is not intended to limit the scope, applicability or configuration of the possible embodiments. Rather, the ensuing description of the exemplary embodiment(s) will provide those skilled in the art with an enabling description for implementing an exemplary embodiment. It should be understood that various changes may be made in the function and arrangement of elements without departing from the spirit and scope of the possible embodiments as set forth in the appended claims.

As explained above, an enterprise plan is a plan that helps determine how to run a business or organization. Enterprise plans, such as the supply chain management plan, include inputs, outputs, constraints, goals, and other information. An input can be any factor that is levied on the plan. For example, an input can be the amount of goods ordered, expected demand, the size of the workforce, etc. An output is any factor generated from the plan. For example, an output may be the number of goods to produce, the number of orders to fill, etc. A constraint is a factor determining how the plan may function. A constraint may be the capacity of a manufacturing line, the number of hours an employee may work by contract, the time required to supply a product to a customer, etc. Finally, a goal may be a factor that the organization wants to maximize. For example, a goal may be maximum profit, lowest costs, etc. These elements (i.e., inputs, outputs, constraints, and/or goals) are used to generate the enterprise plans.

An example of an enterprise plan is a supply chain management plan. A supply chain management plan plans out how many units of a product to make or manufacture, what materials to order and when to be able to manufacture the products, what manufacturing shifts to run and how many people should be on each shift, etc. Thus, a supply chain management plan may have the number of goods orders, the expected future demand projections as inputs, the materials to be ordered, and/or the available employees to work. The outputs may be the number of goods produced. Constraints can include the number of manufacturing lines available, the goods produced by each manufacturing line for a given time period, the length of time to ship a product, etc. The goal may be to maximize profits. All these and other parameters may be considered to generate the supply chain management plan.

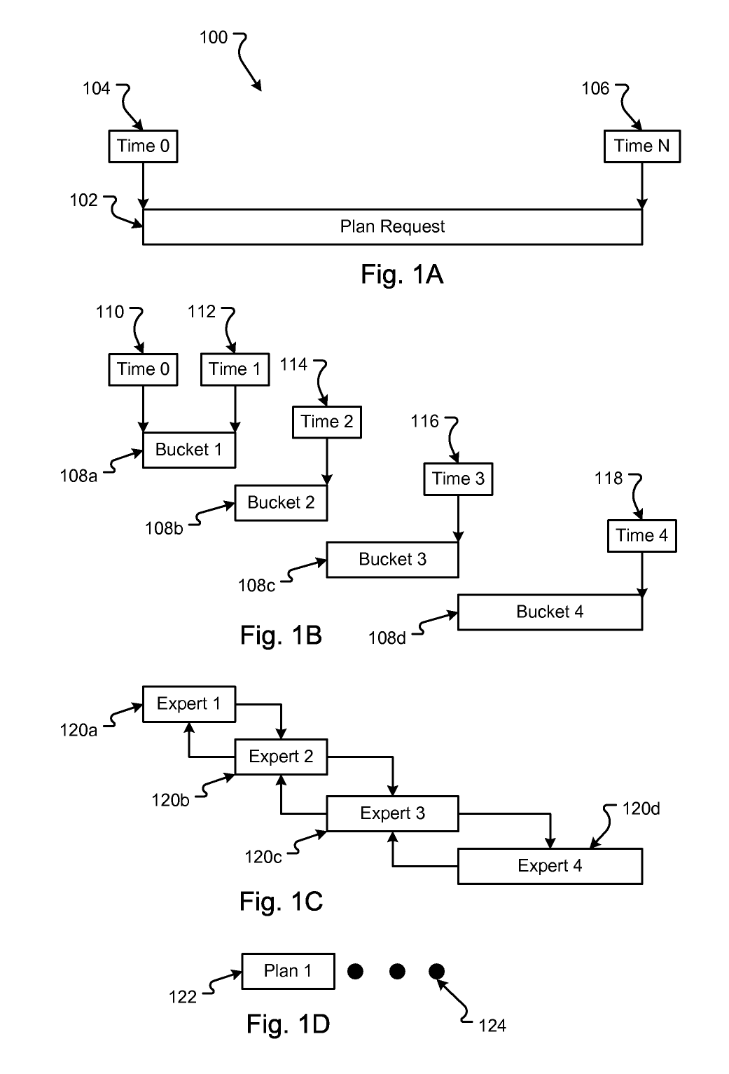

Embodiments of the present disclosure provide unique and novel methods and systems for generating enterprise plans. A planning process 100 of creating the enterprise plan is shown in FIG. 1. The user can request the creation of a plan for a period (e.g., 512 days), as visually represented by the planning period 102. The planning period 102 can have a start time 104, “Time 0,” and an end time 106, “Time N.” For a 512 day planning period, time 0 is day 0 and time N is day 511. An existing planning process would generally try to solve for a plan over this entire planning period. The existing planning process would break the planning period into 512 days, solving each day individually to create a plan over the 512 day period.

Embodiments presented herein, separate the planning period 102 into two or more buckets 108a, 108b, 108c, and/or 108d. A bucket 108 is a defined portion of time within the planning period. For example, a bucket may be a day, two days, a week, a month, or any division of time. The buckets 108 can be defined by a start time, e.g. Time 0 110, and an end time, e.g. Time 1 112. The end time of one bucket 108 can be the start time of the next bucket 108. For example, the end time 112 of bucket 1 108a is the start time of bucket 2 108b. In an embodiment, the buckets 108 can increase in duration the further the planning period 102 is from the start time 104. For example, bucket 1 108a may be a day in duration, bucket 2 108b may be two (2) days in duration, bucket 3 108c may be four (4) days in duration, and bucket 4 108d may be eight (8) days in duration. The duration of the buckets 108 may be governed by a mathematical algorithm or function. For example, the duration of the buckets 108 is governed by an exponential function. Thus, the duration of the buckets 108 increases exponentially the further the planning period 102 is from the start time 104.

Rather than solve for each day, the planning process 100 solves for each bucket 108. Each bucket 108 is resolved for inputs, constraints, orders, demand, output, etc. The enterprise planning process need not resolve each day but each bucket 108, as if the bucket 108 (which may be several days long) were a day in the planning period 102. As such, the planning process 100 solves far fewer periods of time for the planning process 100. For example, an existing planning process would solve for 512 different time periods, as explained above. In contrast, embodiments presented herein using exponentially increasing buckets, with a base 2, would solve 9 buckets (i.e. 29 days=512 days). The time to solve the plan for the same 512 days would decrease almost by a factor of 50. The plan that took eight hours to solve may take 15 minutes. Thus, several plans can be created each day allowing an enterprise to adjust to changes quickly and be more responsive to customer requests.

Further, each bucket 108 can be resolved by a different type of expert 120. An expert 120 is the mathematical or other function used to generate the plan for the bucket. In existing planning processes, the planning process may only employ linear programming (LP) because other methods would take even longer to solve. However, due to the reduction of time needed to solve plans with the embodiments presented herein, each expert 120 may employ one or more different mathematical models. For example, the experts 120 can use linear programs and mixed-integer programming. Other approaches are possible. Further, each expert 120 can use different approaches. Thus, expert 1 120a that solves the plan for bucket 1 108a may use several approaches to get the most accurate plan. Expert 4 120d may use only LP to determine a plan. The plan for bucket 1 108a may then be more accurate than the plan for bucket 4 108d. After the plans for the buckets 108 are generated, the information is aggregated to generate a single plan 122 for the first day or bucket 108. The plan 122 is stored. The plans for the other buckets 108b-108d aggregated into plan 122 may then be discarded. To solve for the plan for the next day, the time frames for the planning period 102 are adjusted by one day and the planning process repeated. Therefore, accurate plans for every day are created iteratively. Further, if there are near term changes (e.g., new orders, changes in capacity, etc.), the plans may be recreated with the new changes. This planning process 100 creates very detailed near term plans quickly and with great flexibility.

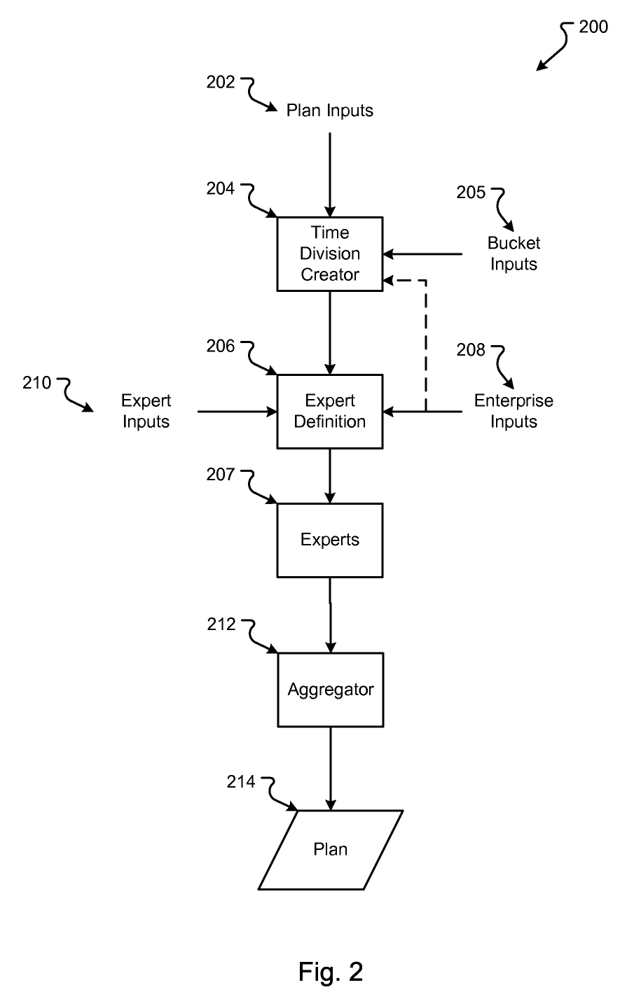

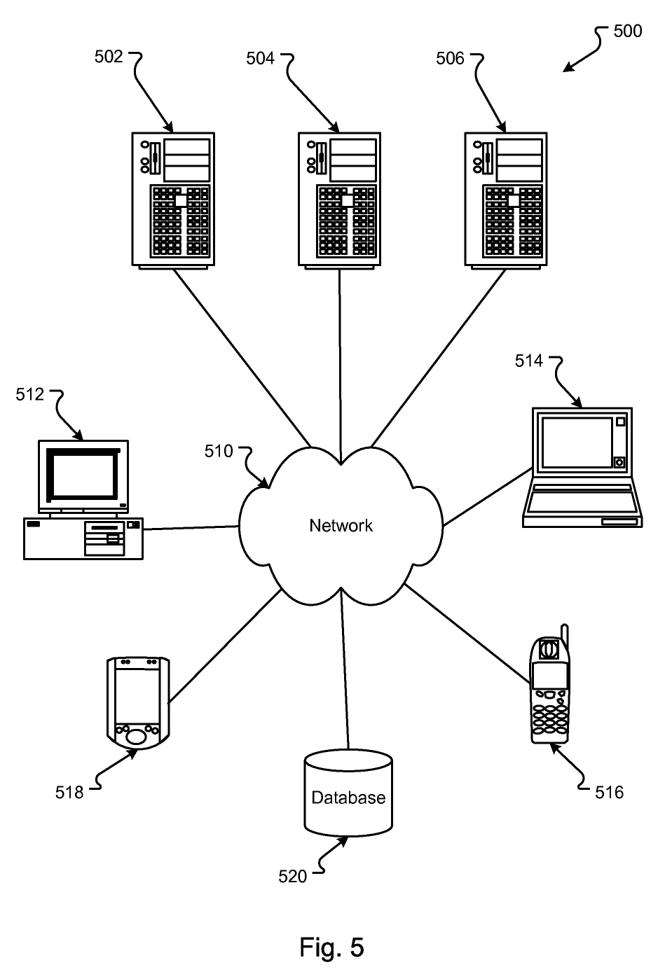

An embodiment of a system 200 for creating an enterprise plan, in the method described in conjunction with FIG. 1, is shown in FIG. 2. The system 200 can be executed in a computing system, as described in conjunction with FIG. 5. The components of system 200 may be hardware, software, or hardware and software. In some embodiments, the components of system 200 can be computer-executable software components executed in a processor. The system 200 can comprise a time division creator 204, an expert definition component 206, which defines two or more experts 207, and/or an aggregator 212. Each component of the system 200 may receive inputs and produce outputs. The outputs may be presented to a user with the computing system as a graphical output on a display screen or as a tangible report printed by an output device. The components of the system 200 can cause the computing system to execute functions, store data, produce outputs, or generally change the state of the computing system.

The first component of the system 200 is the time division creator 204. The time division creator 204 creates the bucket definitions for the buckets 108 (FIG. 1). The time division creator 204 can receive plan inputs 202. The plan inputs 202 can be the definition of the planning period 102 (FIG. 1) or other information that may be needed to create the buckets 108 (FIG. 1). The plan inputs 202 can be provided by a user for each iteration of the planning process 100 (FIG. 1) or may be predetermined. For example, the length of the planning period, e.g. 512 days, may be predetermined and be input for every iteration of the planning process 100 (FIG. 1).

The time division creator 204 may also receive one or more bucket inputs 205. A bucket input 205 can define how the buckets will be created. For example, the duration for each bucket may be entered as a bucket input 205. In other embodiments, a bucket input 205 may provide a mathematical algorithm or model for determining the duration of the buckets 108 (FIG. 1). For example, a exponential function may be entered as a bucket input 205 to determine the lengths of two or more buckets 108 (FIG. 1). The bucket inputs 205 may also be input for each iteration of the planning process 100 (FIG. 1) or may be predetermined. For example, the function for determining the duration of the buckets 108 (FIG. 1), e.g. the exponential function, may be predetermined and be input for every iteration of the planning process 100 (FIG. 1).

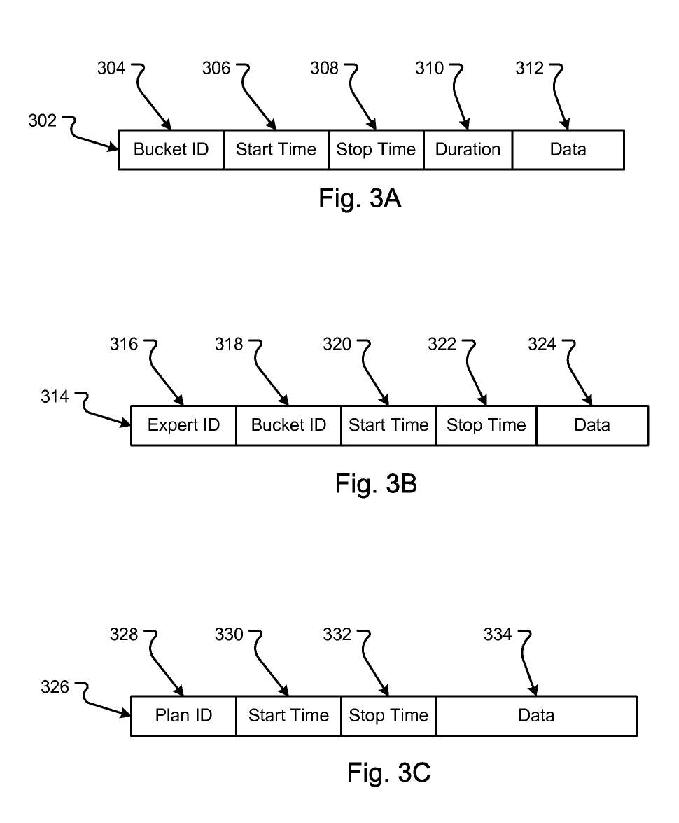

The time division creator 204 can output definitions for two or more buckets 108 (FIG. 1). An embodiment of a bucket division data structure 302 is shown in FIG. 3A. The time division data structure 302 may include one or more data fields. A first data field may be a bucket identifier (ID) 304. The bucket ID 304 can include an identifier, e.g., a globally unique identifier, a unique number, a unique alphanumeric identifier, etc., that can identify the bucket 108 (FIG. 1). A second field may be a start time field 306. The start time field 306 can define the start time for the bucket 108 (FIG. 1). In other words, the start time field 306 includes a date and/or time when inputs, outputs, or constraints that occur after the start time are assigned to the bucket 108 (FIG. 1). Likewise, a stop time field 308 defines the stop time such that inputs, outputs, or constraints that occur after the stop time are not assigned to the bucket 108 (FIG. 1). The optional duration field 310 may include the number of days or time units defining the length of the bucket 108 (FIG. 1).

Further, the time division data structure 302 (also referred to as a “bucket”) can include a data field 312 storing enterprise inputs 208. The enterprise inputs 208 stored in the data field 312 may include all the inputs, outputs, constraints, etc. associated with the buckets 108. The time division creator 204 can compare when inputs, outputs, and constraints occur against the start time 306 and the stop time 308 to determine if the inputs, outputs, and constraints should be stored in the data section 312. For example, if an order occurs after the start time 306 and before the stop time 308, then the order is included as an input in the data field 312. In other embodiments, the inputs, outputs, and constraints are stored separately and the data field includes a pointer or link to the data for the inputs, outputs, and constraints.

Referring again to FIG. 2, the time division creator 204 can send the two or more time definitions 302 (FIG. 3) to the expert definition component 206. The expert definition component 206 may receive the information about the buckets 108 from the time division creator 204. The expert definition component 206 may then define two or more experts 207 for each bucket 108 and associate each expert 207 with a bucket 108. The expert definition component 206 may then receive the enterprise inputs 208 and determine which expert 206 receives each input 208. The expert definition component 206 can compare when inputs, outputs, and constraints occur against the start time 306 and the stop time 308 to determine if the inputs, outputs, and constraints should be associated with the expert 206 associated with the bucket 108. The expert definition component 206 can also receive expert inputs 210 that define the function of the experts 207. For example, an expert input 210 can include the types of expert solution approach each expert 207 is to use.

An embodiment of a defined expert data structure 314 is shown in FIG. 3B. The expert data structure 314 may also include one or more data fields. The data fields may include an expert identifier 316, a bucket identifier 318, a start time field 320, a stop time field 322, and/or a data field 324. The expert ID 316 and/or the bucket ID 318 are identifiers, e.g., a globally unique identifier, a unique number, a unique alphanumeric identifier, etc., that can identify the expert 207 (FIG. 2) and the bucket 108 (FIG. 1), respectively. The bucket ID 318 can be the same as bucket ID 304 and associate the expert with the bucket. A second field may be a start time field 320. The start time field 320 can be the same as the start time field 306 of the associated bucket and can define the start time for the expert 207. In other words, the start time field 320 includes a date and/or time when inputs, outputs, or constraints that occur after the start time are assigned to the expert 207. Likewise, a stop time field 322, which may be the same as the stop time field 308, defines the stop time such that inputs, outputs, or constraints that occur after the stop time are not assigned to the expert 207.

Further, the expert data structure 314 includes a data field 324 storing enterprise inputs 208 and/or expert inputs 210. The enterprise inputs 208 stored in the data field 312 may include all the inputs, outputs, constraints, etc. associated with the buckets 108. The expert definition component 206 can compare when inputs, outputs, and constraints occur against the start time 320 and the stop time 322 to determine if the inputs, outputs, and constraints should be stored in the data section 324. For example, if an order occurs after the start time 320 and before the stop time 322, then the order is included as an input in the data field 324. In other embodiments, the inputs, outputs, and constraints are stored separately and the data field includes a pointer or link to the data for the inputs, outputs, and constraints. Further, the data field 324 can store the expert inputs 210. The stored expert inputs 210 can include the expert solution approach or algorithms to be used in solving the expert.

The experts 207 then solve the expert solution approach associated with the experts 207 with respect to the inputs 208 and/or 210 associated with the experts 207. Thus, for each duration of time determined by the buckets 302 (also referred to as a “bucket”), the experts 207 each create a plan. The experts 207 can share outputs and inputs with other experts 207 and change the plans for the experts 207. Then, an aggregator 212 can aggregate the plans from the different experts 207 to create a single plan 214 associated with the first time duration (e.g., day) for the planning period. The plans created by the experts 207 may then be discarded. A user can then create a plan for the next time duration by changing the plan inputs 202 and reiterating the process.

The plan created by the process can be stored as a plan data structure 326 as shown in FIG. 3C. The plan data structure 326 can include a plan identifier 328, a start time field 330, a stop time field 332, and/or a data field 334. The plan ID 328 is an identifier, e.g., a globally unique identifier, a unique number, a unique alphanumeric identifier, etc., that can identify the plan 214. The start time field 330 can define the first time or date for the beginning of the plan, while the stop time field 332 can define the end of the plan. If the plan is one day long, then the start time is midnight of the day and the stop time is 11:59 p.m. of the day. The data field 334 can include all the required information for executing the plan, e.g., what to order during the day, what to manufacture and how many units, the people to be staffed in various positions, etc. If the process is reiterated, a next plan 326 with a new plan ID 328 is created. The next plan should have consecutive start and stop times, e.g., the start time is midnight of the next day.

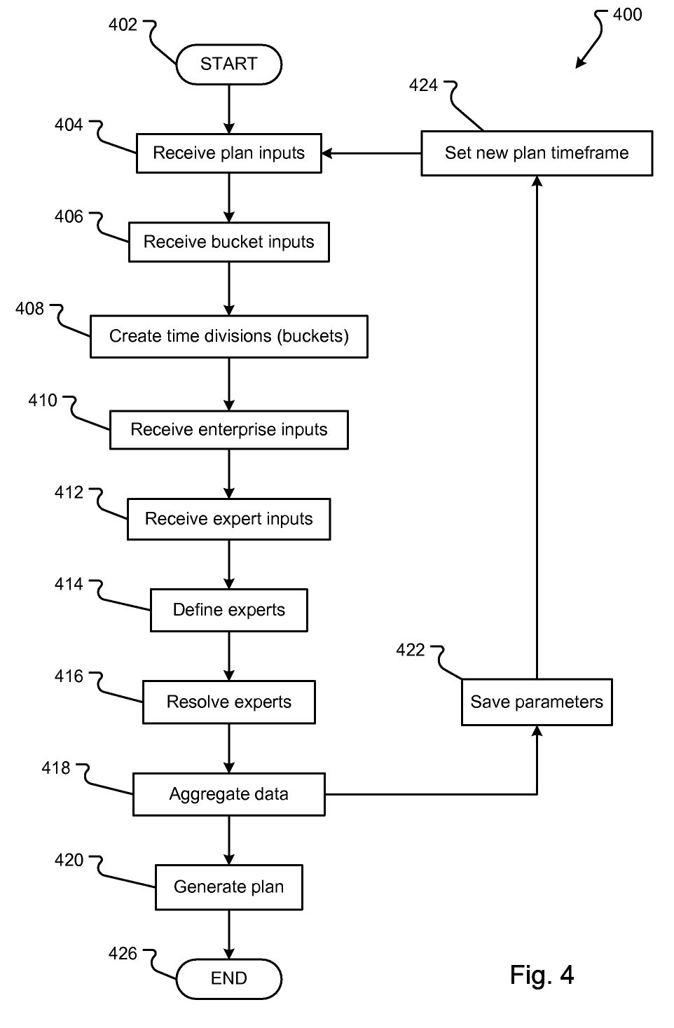

An embodiment of a method 400 for generating an enterprise plan is shown in FIG. 4. In embodiments, the method 400 generally begins with a START operation 402 and terminates with an END operation 426. The steps shown in the method 400 may be stored on a computer-readable medium or as a computer program product and executed in a computer system as a set of computer-executable instructions. While a logical order is shown in FIG. 4, the steps shown or described can, in some circumstances, be executed in a different order than presented herein. The method 400 will be described with reference to the processes, systems, and data structures shown in FIGS. 1-3C. Therefore, the description contains reference numerals found in one or more of those figures.

A computing system executing a time division creator 204 receives one or more plan inputs 202 in step 404. The plan inputs 202 can define a planning period 102 for the enterprise to be created. In embodiments, a request to create the enterprise plan is also received. One or more bucket inputs 205 are received by the time division creator 204 in step 406. The bucket inputs 205 can include how many time divisions should be created for the planning period 102, how the time divisions are created (e.g., with an exponential algorithm), and/or the duration for one or more time divisions.

The time division creator 204 creates buckets 108 for the time divisions, according to the plan inputs 202 and the bucket inputs 205, in step 408. The time division creator 204 can define the number of buckets 108. For each bucket, the time division creator 204 may create a bucket division data structure 302. Then, the time division creator 204 determines a start time and a stop time to bound the buckets. The start time and stop time may be stored in fields 306 and 308, respectively, of the bucket division data structure 302. In embodiments, the time division creator 204 receives enterprise inputs 208 (e.g., inputs, outputs, and/or constraints) and compares a time stamp or other data for the enterprise inputs 208 against the start and stop time. If the time stamp for the enterprise inputs 208 is after the start time and before the stop time (i.e., between the start time and the stop time), the time division creator 204 stores the enterprise input 208 in a data field 312 of the bucket division data structure 302. If the time stamp for the enterprise inputs 208 is not between the start time and the stop time, the enterprise input 208 is ignored. After creating the bucket 108, the time division creator 204 provides the bucket to the expert definition component 206.

The expert definition component 206 receives enterprise inputs 208 in step 410. The user may enter the enterprise inputs 208, the enterprise inputs 208 may be predetermined or the enterprise inputs 208 may be automatically provided (e.g., orders are received from an ordering system automatically). The expert definition component 206 also receives expert inputs 210 (e.g., the expert solution approach to solve an expert) in step 412. The user may enter the expert inputs 210 or the expert inputs 210 may be predetermined. For example, the expert solution approach used for each expert may be predetermined.

The expert definition component 206 defines the experts in step 414. The expert definition component 206 may create an expert definition data structure 314. The bucket ID 304 from the bucket 302 can be stored in a bucket ID field 318 to associate the expert 207 with a bucket 108. The start time 306 and stop time 308 from the bucket 302 may also be stored in a start time field 320 and a stop time field 332, respectively. Finally, the expert definition component 206 can store the enterprise inputs 208 and expert inputs 210 that apply to the expert 207 in a data field 324. Enterprise inputs 208 apply to the expert 207 if a time stamp associated with the enterprise inputs 208 is between the start time 320 and stop time 322. The expert inputs 210 may identify a particular bucket, by identifier 304, by stop time 306 and start time 308, or by the number in a bucket order (e.g., 2^{nd} bucket in eight). The expert definition component 206 can use the identification to associate the expert inputs 210 with the experts 207.

Each expert 207 resolves its plan in step 416. In other words, each expert determines how to best plan for the enterprise inputs 208 associated with the expert using the expert solution approach provided with the expert inputs 210. The data is aggregated in step 418. Aggregator 212 aggregates the data by determining the effect each expert 207 has on the previous and subsequent experts 120 (as shown in FIG. 1C). Thus, the aggregator 212 determines the effect of all experts 120b, 120c, and 120d on a first expert 120a. The aggregator 212 then generates the plan 122 for the first expert 120a associated with the first bucket 108a in step 420. The plan data structure 326 may have one or more data fields created by the aggregator 212 or expert 207.

If the user desires to determine a plan for a next day, the aggregator 212 or other component saves the parameters for the plan data structure 326 in step 422. The saved parameters can be used to generate the next day's plan as inputs or constraints. The planning period 102 for the new plan is set in step 424. In embodiments, the user provides a planning period 102 by specifying a new start time 104 to begin the next day. The process is reiterated or repeated as represented by the method 400 returning to the receive step 404.

A set of embodiments comprises systems for processing data with an enterprise planning application, for selecting enterprise data to be processed, and/or for configuring expert modeling. Merely by way of example, FIG. 5 illustrates a schematic diagram of a system 500 that can be used in accordance with one set of embodiments. The system 500 can include one or more user computers 512. The user computers 512 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 512 can also have any of a variety of applications, including one or more applications configured to perform methods of various embodiments, as well as one or more office applications, database client and/or server applications, and web browser applications. Alternatively, the user computers 512 can be any other electronic device, such as a thin-client computer, a laptop 514, an Internet-enabled mobile telephone 516, and/or a personal digital assistant 518, capable of communicating via a network (e.g., the network 510 described below) and/or displaying and navigating web pages or other types of electronic documents. Although the exemplary system 500 is shown with one user computer 512, any number of user computers can be supported.

Certain embodiments may operate in a networked environment, which can include a network 510. The network 510 can be any type of network familiar to those skilled in the art that can support data communications using any of a variety of commercially available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Some embodiments can include one or more server computers 502, 504, and/or 506. Each of the server computers 502, 504, and/or 506 may be configured with an operating system, including without limitation any of those discussed above, as well as any commercially (or freely) available server operating systems. Each of the servers 502, 504, and/or 506 may also be running one or more applications, which can be configured to provide services to one or more clients or use computers 512 and/or other servers 502, 504, and/or 506.

Merely by way of example, one of the servers 502, 504, and/or 506 may be a web server, which can be used, merely by way of example, to process requests for web pages or other electronic documents from user computers 512. The web server can also run a variety of server applications, including HTTP servers, FTP servers, CGI servers, database servers, Java servers, and the like. In some embodiments, the web server may be configured to serve web pages that can be operated within a web browser on one or more of the user computers 512 to perform methods of various embodiments.

The server computers 502, 504, and/or 506, in some embodiments, might include one or more application servers, which can include one or more applications accessible by a client running on one or more of the use computers 512 and/or other servers 502, 504, and/or 506. Merely by way of example, the server(s) 502, 504, and/or 506 can be one or more general purpose computers capable of executing programs or scripts in response to the user computers 512 and/or other servers 502, 504, and/or 506, including without limitation web applications (which might, in some cases, be configured to perform methods of certain embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle, Microsoft, Sybase™, IBM™ and the like, which can process requests from clients (including, depending on the configuration, database clients, API clients, web browsers, etc.) running on a user computer 512 and/or another server 502, 504, and/or 506. In some embodiments, an application server can create web pages dynamically for displaying the information in accordance with various embodiments, such as user interfaces for operating and/or configuring a population selection engine, as described above, for example. Data provided by an application server may be formatted as web pages (comprising HTML, Javascript, etc., for example) and/or may be forwarded to a user computer 512 via a web server (as described above, for example). Similarly, a web server might receive web page requests and/or input data from a user computer 512 and/or forward the web page requests and/or input data to an application server. In some cases a web server may be integrated with an application server.

In accordance with further embodiments, one or more servers 502, 504, and/or 506 can function as a file server and/or can include one or more of the files (e.g., application code, data files, etc.) necessary to implement methods incorporated by an application running on a user computer 502 and/or another server 502, 504, and/or 506. Alternatively, as those skilled in the art will appreciate, a file server can include all necessary files, allowing such an application to be invoked remotely by a user computer 512 and/or server 502, 504, and/or 506. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 502, 504, and/or 506 (and/or a user computer 512). Alternatively, a database 520 can be remote from any or all of the computers 512, 502, 504, and/or 506, so long as it can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 512, 502, 504, and/or 506 can be stored locally on the respective computer and/or remotely, as appropriate.) In one set of embodiments, the database can be a relational database, such as an Oracle database, that is adapted to store, update, and retrieve data in response to SQL-formatted commands. The database might be controlled and/or maintained by a database server, as described above, for example.

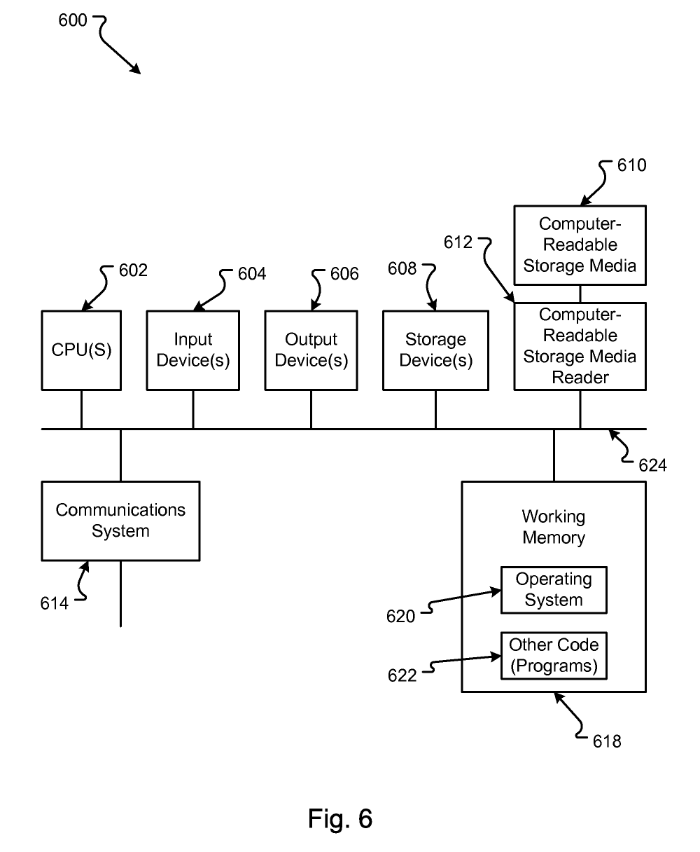

FIG. 6 provides a schematic illustration of one embodiment of a computer system 600 that can perform the methods provided by various embodiments, as described herein, and/or can function as a computer system (including without limitation a server computer, a client computer, etc.). It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 624 (or may otherwise be in communication, as appropriate). The hardware elements can include one or more processors 602, including without limitation one or more general-purpose processors and/or one or more special-purpose processors (such as digital signal processing chips, graphics acceleration chips, and/or the like); one or more input devices 604, which can include without limitation a mouse, a keyboard and/or the like; and one or more output devices 606, which can include without limitation a display device, a printer and/or the like.

The computer system 600 may further include (and/or be in communication with) one or more storage devices 608, which can comprise, without limitation, local and/or network accessible storage and/or can include, without limitation, a disk drive, a drive array, an optical storage device, a solid-state storage device such as a random access memory (“RAM”) and/or a read-only memory (“ROM”), which can be programmable, flash-updateable and/or the like. The computer system 600 might also include a communications subsystem 614, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 614 may permit data to be exchanged with a network (such as the network described below, to name one example), and/or any other devices described herein. In many embodiments, the computer system 600 will further comprise a working memory 618, which can include a RAM or ROM device, as described above.

The computer system 600 also can comprise software elements, shown as being currently located within the working memory 618, including an operating system 620 and/or other code, such as one or more application programs 622, which may comprise computer programs provided by various embodiments, and/or may be designed to implement methods, and/or configure systems, provided by various embodiments, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 608 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, certain embodiments employ a computer system (such as the computer system 600) to perform methods provided by other embodiments. According to a set of embodiments, some or all of the procedures of such methods are performed by the computer system 600 in response to processor 602 executing one or more sequences of one or more instructions (which might be incorporated into the operating system 620 and/or other code, such as an application program 622) contained in the working memory 618. Such instructions may be read into the working memory 618 from another machine-readable medium, such as one or more of the storage device(s) 608. Merely by way of example, execution of the sequences of instructions contained in the working memory 618 might cause the processor(s) 602 to perform one or more procedures of the methods described herein.

The terms “machine-readable medium” or “computer-readable medium” 610, as used herein, refer to any medium that participates in providing data that causes a machine to operation in a specific fashion. In an embodiment implemented using the computer system 600, various machine-readable media might be involved in providing instructions/code to processor(s) 602 for execution and/or might be used to store and/or carry such instructions/code (e.g., as signals). In many implementations, a computer readable medium is a physical and/or tangible storage medium. Such a medium may take many forms, including, but not limited to, non-volatile media, volatile media, and transmission media. Non-volatile media includes, for example, optical or magnetic disks, such as the storage device(s) 608. Volatile media includes, without limitation, dynamic memory, such as the working memory 618. Transmission media includes coaxial cables, copper wire and fiber optics, including the wires that comprise the bus 624, as well as the various components of the communication subsystem 614 (and/or the media by which the communications subsystem 614 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions read by a computer-readable storage media reader 612 and provided to the processor(s) 602 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments.

The communications subsystem 614 (and/or components thereof) generally will receive the signals, and the bus 624 then might carry the signals (and/or the data, instructions, etc. carried by the signals) to the working memory 618, from which the processor(s) 602 retrieves and executes the instructions. The instructions received by the working memory 618 may optionally be stored on a storage device 608 either before or after execution by the processor(s) 602.

While various aspects of embodiments of the disclosure have been summarized above, the following detailed description illustrates exemplary embodiments in further detail to enable one of skill in the art to practice the disclosure. In the description, for the purposes of explanation, numerous specific details are set forth in order to provide a thorough understanding of the present disclosure. It will be apparent, however, to one skilled in the art that the present disclosure may be practiced without some of these specific details. In other instances, well-known structures and devices are shown in block diagram form. Several embodiments of the disclosure are described, and while various features are ascribed to different embodiments, it should be appreciated that the features described with respect to one embodiment may be incorporated with another embodiment as well. By the same token, however, no single feature or features of any described embodiment should be considered essential to the disclosure, as other embodiments of the disclosure may omit such features.

Specific details are given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. A computing system may be used to execute any of the tasks or operations described herein. In embodiments, a computing system includes memory and a processor and is operable to execute computer-executable instructions stored on a computer-readable medium that define processes or operations described herein.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as a storage medium. A processor(s) may perform the necessary tasks. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

In light of the above description, a number of advantages of the present disclosure are readily apparent. For example, the enterprise planning process is much more efficient. Rather than solving a large plan and determining solutions for each day, several plans are created with fewer solutions. The detailed plans are created for timeframes closer to the present time while less detailed plans are created for timeframes further in the future.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

While the principles of the disclosure have been described above in connection with specific apparatuses and methods, it is to be clearly understood that this description is made only by way of example and not as limitation on the scope of the disclosure.

What is claimed is:

1. A computing system operable to generate an enterprise plan for a timeframe, the computing system comprising:
a processor;
a memory in communication with the processor, the memory storing computer-executable instructions operable to cause the processor to execute software components, the software components comprising
a time division creator, the time division creator operable to define two or more buckets;
an expert definition component in communication with the time division creator, the expert definition component operable to receive the buckets, define an expert for each bucket, and associate the experts with the buckets;
two or more experts, the two or more experts operable to generate a plan for a duration represented by the associated bucket; and
an aggregator in communication with the two or more experts, the aggregator operable to aggregate the results of the two or more experts into the enterprise plan and operable to provide the enterprise plan.

2. The computing system as defined in claim 1, wherein each bucket has a start time and a stop time and a duration for each bucket is less than a duration for the timeframe.

3. The computing system as defined in claim 2, wherein the expert definition component is operable to receive an enterprise input.

4. The computing system as defined in claim 3, wherein the expert definition component is operable to compare a time stamp associated with enterprise input to the start time and stop time of at least one bucket, and the expert definition component is operable to associate the enterprise input with the expert wherein the time stamp is after the start time and before the stop time.

5. The computing system as defined in claim 1, wherein the expert definition component is operable to receive an expert input, the expert input defining an expert solution approach to use for at least one expert.

6. The computing system as defined in claim 5, wherein the expert solution approach is one of linear programming or mixed-integer programming.

7. The computing system as defined in claim 5, wherein the expert solution approach is a heuristic or approximate algorithm.

8. The computing system as defined in claim 1, wherein a first bucket has a first duration and a second bucket has a second duration and the first duration and second duration are different.

9. The computing system as defined in claim 8, wherein the first duration and the second duration are determined using a mathematical algorithm.

10. The computing system as defined in claim 9, wherein the mathematical algorithm is an exponential algorithm

11. A computer-executable method for generating an enterprise plan having a timeframe, the method comprising:
an input device receiving a plan input, the plan input defining the timeframe;
a processor receiving at least one bucket input;
the processor defining two or more buckets for the timeframe based on at least one bucket input, wherein the buckets are time divisions of the timeframe;
the processor receiving at least one enterprise input;
the processor defining two or more experts, each expert associated with a bucket and based on at least one enterprise input;
the processor resolving the two or more experts;
the processor aggregating the experts; and
the processor providing the enterprise plan.

12. The computer-executable method as defined in claim 11, further comprising:
the processor receiving at least one expert input; and
the processor defining the two or more experts based on at least one expert input.

13. The computer-executable method as defined in claim 12, wherein the expert input is an expert solution approach to use for at least one of the experts.

14. The computer-executable method as defined in claim 11, wherein the plan input is a mathematical algorithm for determining the duration of the two or more buckets.

15. The computer-executable method as defined in claim 14, wherein the timeframe has a start time and a stop time, wherein the mathematical algorithm is an exponential algorithm, and wherein the bucket duration increases as the start time of the bucket is further from the start time of the timeframe.

16. The computer-executable method as defined in claim 11, wherein the enterprise input includes one of inputs, outputs, or constraints.

17. The computer-executable method as defined in claim 11, further comprising:
saving one or more parameters associated with the enterprise plan;
setting a new timeframe; and
reiterating the computer-executable method to generate a second enterprise plan for the new timeframe.

18. The computer-executable method as defined in claim 11, wherein the enterprise plan is a plan for a first day of the timeframe.

19. A computer program product stored on a computer-readable medium and including computer-executable instructions executable by a processor and causing the processor to perform one or more functions, the computer program product comprising:
instructions to receive a plan input, the plan input defining a timeframe, the timeframe having a start time and a stop time;
instructions to receive at least one bucket input, wherein at least one bucket input defines a mathematical algorithm to define a duration for each bucket;
instructions to define two or more buckets for the timeframe based on at least one bucket input, wherein the buckets are time divisions of the timeframe, and wherein the duration of each bucket increases exponentially based on the mathematical algorithm;
instructions to receive at least one enterprise input, wherein the enterprise input includes at least one of an input, an output, or a constraint;
instructions to receive at least one expert input, wherein the expert input defines an expert solution approach by which the expert is resolved;
instructions to define two or more experts, each expert associated with a bucket and based on at least one enterprise input and at least one expert input;
instructions to resolve the two or more experts;
instructions to aggregate the experts; and
instructions to provide the enterprise plan.

20. The computer program product as defined in claim 19, wherein the provided enterprise plan is for a first day of the timeframe.

21. The computer program product as defined in claim 20, further comprising:
instructions to save one or more parameters associated with the enterprise plan;
instructions to set a new timeframe, with a new start time, wherein the new start time is a next day after the end of the enterprise plan; and
instructions to reiterate the computer-executable instructions to generate a second enterprise plan for the new timeframe.
